(19) United States
(12) Patent Application Publication
(10) Pub. No.: US 2005/0087428 A1
(43) Pub. Date: Apr. 28, 2005

(54) Flush mounted motorized roller for conveyor

(76) Inventors: Thomas J. Pelak, Grand Rapids, MI (US); Daniel R. Bigelow, Walker, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/975,913

(22) Filed: Oct. 28, 2004

Related U.S. Application Data
(60) Provisional application No. 60/481,570, filed on Oct. 28, 2003.

(51) Int. Cl. B65G 13/02

(52) U.S. Cl. 198/780; 198/788

(57) ABSTRACT

A motorized roller for a conveyor includes a non-rotatable portion and a roller portion that is rotatably driven relative to the non-rotatable portion via an internal motor. The non-rotatable portion includes hubs or ends that are mounted to the opposed surfaces of opposite sidewalls or mounting portions of a conveyor, such that the motorized roller is positioned entirely between the mounting portions. The motorized roller may be secured to the mounting portions via at least one fastener extending through the mounting portions and at least partially into the respective hub or end of the non-rotatable portion of the motorized roller. The motorized roller may include an electrical connector integral with one of the hubs for electrically connecting the motorized roller to a corresponding connector of the conveyor. The motorized roller thus may be generally flush-mounted between the mounting portions of the conveyor.

### CROSS REFERENCE TO RELATED APPLICATION

The present application claims benefit of U.S. provisional application, Ser. No. 60/481,570, filed Oct. 28, 2003, which is hereby incorporated herein by reference in its entirety.

### FIELD OF THE INVENTION

The present invention relates generally to conveyors and, more particularly, to conveyors that are driven by a motorized or self-driven or powered roller or pulley.

### BACKGROUND OF THE INVENTION

A belt conveyor or a roller conveyor may be powered or driven by a motorized pulley or motorized roller that is operable to drive the belt and/or idler rollers of the conveyor. The rollers for such conveyors are typically mounted at and between opposite sidewalls of the conveyor via an axle or shaft portion of the rollers extending or protruding at least partially through a mounting block or mounting member affixed at or to the outer portion of the sidewall of the conveyor. The mounting block may provide a correspondingly formed hole or aperture for non-rotatably receiving the shaft portion therein to mount the roller at the sidewalls. In some applications, the shaft or shaft portions of the roller may be spring-loaded to allow for retraction of the shaft or shaft portion at one or both of the ends of the roller to facilitate mounting of the roller to the mounting blocks at the sidewalls. One of the shaft ends may be inserted through the opening in one of the mounting blocks and the roller may then be pivoted downward to move the other shaft end of the roller to align with the opening in the other mounting block at the opposite sidewall. The shaft or shaft portion at the other end of the roller may be retracted to allow clearance of the shaft at that end as the roller is pivoted downward to align with the corresponding aperture in the other mounting block. The shaft end is typically biased outwardly so that when it is released it extends through the opening in the mounting block to mount the roller to the mounting blocks at the conveyor sidewalls.

Typically, the mounting blocks are positioned at or partially at or within the outer sides of the sidewalls or at the outer side channels of the sidewalls. The mounting blocks may be at least partially positioned within the side channel area, and thus may interfere with the space along the side channel where it may be desired to position various electronic wirings and/or components. After the rollers are mounted at and between the sidewalls, the shafts or shaft portions may also protrude outwardly from the outer sides of the sidewalls and from the mounting blocks and may further interfere with the space along the side channels. The wires or connectors of the motorized roller often are fed through the axle portion and/or the sidewall of the conveyor for connection to the controls of the conveyor.

Therefore, there is a need in the art for a roller conveyor that overcomes the shortcomings of the prior art.

### SUMMARY OF THE INVENTION

The present invention provides a generally flush mounted motorized roller or pulley for a conveyor, such as for a belted conveyor or a roller conveyor or the like. The motorized roller includes generally flat mounting portions or end portions or hubs that are mountable to the inner or opposed sides or surfaces of the sidewalls or mounting portions of the conveyor, such that the hubs do not interfere with the space along the outer side channels of the conveyor sidewalls. The motorized roller thus may be flush mounted at the inner sides or surfaces of the sidewalls. The end portions or hubs allow the roller to be vertically moved or lowered or dropped generally vertically downward or raised generally vertically upward between the sidewalls to mount the roller between the sidewalls. The motorized roller may be operable to drive a continuous belt routed or reeved around the motorized roller and at least one other idler roller or pulley of a belted conveyor section, or may be operable to rotatably drive a plurality of idler or slave rollers of a roller conveyor section, such as via one or more O-rings or the like or via other means, without affecting the scope of the present invention.

According to an aspect of the present invention, a conveyor for conveying articles along a conveying surface includes a pair of opposite sidewalls, at least one idler roller mounted to the sidewalls, and a motorized roller mounted to the sidewalls. The motorized roller includes a non-rotatable portion mounted to and between the sidewalls, a rotatable roller portion and an internal motor operable to rotate the roller portion relative to the non-rotatable portion. The non-rotatable portion is positionable entirely between the sidewalls and is mounted to the sidewalls via at least one fastener extending through a respective sidewall and at least partially through a respective end of the non-rotatable portion. The conveyor includes at least one drive member reeved around the motorized roller and the idler roller or rollers, wherein actuation of the motor of the motorized roller drives the drive member and the idler rollers.

The motorized roller includes an electrical connector for connecting the internal motor to a control of the conveyor. The electrical connector is positioned entirely between the sidewalls when the motorized roller is mounted to the sidewalls.

Optionally, the conveyor may comprise a belt conveyor, with the drive member comprising a continuous belt reeved around the motorized roller and at least one idler roller and defining a conveying surface of the belt conveyor. Optionally, the conveyor may comprise a roller conveyor, with a plurality of idler rollers defining a conveying surface of the roller conveyor.

At least one of the ends of the non-rotatable portion may be adjustable to adjust a length of the non-rotatable portion to adapt the non-rotatable portion to fit between the sidewalls. The adjustable end or ends of the non-rotatable portion may be retractable to a retracted position such that the non-rotatable portion fits between the sidewalls, and may be extendable to an extended position via tightening of the fasteners at the sidewalls.

One of the ends of the non-rotatable portion may include the electrical connector, and a respective one of the sidewalls may include a hole positioned adjacent to the electrical connector when the motorized roller is positioned between and mounted to the sidewalls. The electrical connector may be connectable to a second connector of the conveyor for powering and/or controlling the motorized roller. Optionally, a connector and wire may extend from an end of the motorized roller and may be positioned along a groove or channel at least partially across the end of the roller. The wire thus may be positioned within the groove and between the end of the roller and the sidewall of the conveyor.

Optionally, the conveyor may comprise multiple zones, with each zone of the conveyor including a respective motorized roller, which may be selectively operable to rotate or rotatably drive at least one idler roller of the zone. The motorized rollers may be selectively actuatable and may drive the drive member and the at least one idler roller in either direction. The motorized rollers may be selectively operable in response to an article sensor positioned at at least some of the zones and may be selectively operable to accumulate articles on the zones of the conveyor.

According to another aspect of the present invention, a motorized roller is operable to rotatably drive at least one idler roller of a conveyor via at least one drive member reeved around the motorized roller and the at least one idler roller. The idler roller or rollers is/are mounted to opposite sidewalls of the conveyor. The motorized roller includes a non-rotatable portion, a rotatable roller portion rotatable about the non-rotatable portion, and an internal motor positioned within the motorized roller. The non-rotatable portion has opposite ends, with at least one of the ends being retractable to a retracted position. The non-rotatable portion is adapted to fit between opposite mounting portions of the conveyor when the end is in the retracted position. The non-rotatable portion is securable to the opposite mounting portions and is securable entirely between the opposite mounting portions. The non-rotatable portion is mounted to the opposite mounting portions via at least one fastener extending through a respective mounting portion and at least partially through a respective one of the ends of the non-rotatable portion. The internal motor is operable to rotatably drive the roller portion relative to the non-rotatable portion. The motorized roller includes an electrical connector for electrically connecting the internal motor to a control of a conveyor. The electrical connector is positioned entirely within the opposite mounting portions of the conveyor when the motorized roller is mounted to mounting portions of the conveyor.

According to another aspect of the present invention, a method of installing a motorized roller to a conveyor includes providing a motorized roller having a non-rotatable portion having opposite ends, a rotatable roller portion rotatable about the non-rotatable portion, and an internal motor operable to rotatably drive the roller portion relative to the non-rotatable portion. At least one of the ends of the non-rotatable portion is retracted to a retracted orientation. The motorized roller is generally vertically moved, such as lowered or raised, between opposite mounting portions of the conveyor. The motorized roller is movable in a substantially horizontal orientation to a level where the motorized roller is positioned entirely between the opposite mounting portions. The ends of the non-rotatable portion are secured to the respective mounting portions via at least one fastener extending through the mounting portion and at least partially into the respective end of the non-rotatable portion. The fasteners are tightened to secure the motorized roller to the mounting portions. The motorized roller is entirely positioned between the mounting portions when the motorized roller is secured to the mounting portions.

The retracted end of the non-rotatable portion may be extended to an extended position via tightening the fasteners. The motorized roller includes an electrical connector contained entirely between the opposite ends of the roller. The method includes electrically connecting the electrical connector to an electrical control of the conveyor. For example, a conveyor connector may be inserted through an opening in one of the mounting portions and connected to or plugged into a roller connector at a respective one of the ends of the non-rotatable portion of the motorized roller. Optionally, a wire and connector may extend from an end of the motorized roller for connecting to a conveyor connector. The roller connector may connect to the conveyor connector before the roller is moved to the appropriate position at and between the mounting portions, and the wire or lead may be positioned along a groove at the end of the roller to position the wire between the end of the roller and the respective mounting portion when the roller is mounted to the mounting portions.

Therefore, the present invention provides a conveyor powered or driven by a motorized roller, whereby the motorized roller is operable to drive a continuous conveyor belt of a belted conveyor or at least some of the idler rollers of a roller conveyor. The motorized roller may include end portions or hubs that may mount or attach to the inside of the sidewalls or mounting portions of the conveyor, such that the motorized roller is generally flush mounted to the sidewalls or mounting portions and does not interfere with the space along the outer side channels of the conveyor sidewalls. The end portions of the motorized roller allow the roller to be moved or dropped or lowered generally vertically downward or raised generally vertically upward between the sidewalls to mount the roller between the sidewalls, thereby easing the assembly, installation and eventual maintenance processes of the motorized roller and the conveyor. The motorized roller may be electrically connected to a control or power source of the conveyor via electrical connectors or connecting elements that are contained between the sidewalls of the conveyor when the motorized roller is mounted at the sidewalls of the conveyor.

These and other objects, advantages, purposes and features of the present invention will become more apparent upon review of the following specification in conjunction with the drawings.

### BRIEF DESCRIPTION OF THE DRAWINGS

FIG. 1 is an end elevation of a belted conveyor section having a motorized or self-driven roller or pulley in accordance with the present invention;

FIG. 2 is a plan view of the belted conveyor section of FIG. 1;

FIG. 3 is a sectional view of the belted conveyor section taken along the line III-III in FIG. 2;

FIG. 4 is an enlarged perspective view of a portion of the belted conveyor section, with the continuous belt and other rollers removed to show the motorized roller or pulley of the present invention;

FIG. 5 is an end elevation of the conveyor section of FIG. 4;

FIG. 6 is a plan view of the motorized roller or pulley of the present invention;

FIG. 7 is a perspective view of the motorized roller of FIG. 6;

FIG. 8 is an end elevation of the motorized roller of FIG. 7;

FIG. 9 is an end elevation of the motorized roller, showing the opposite end of the roller from the end shown in FIG. 8;

FIG. 10 is a plan view of a power pack assembly or cartridge for a motorized roller or pulley in accordance with the present invention;

FIG. 11 is a perspective view of another motorized roller or pulley in accordance with the present invention;

FIG. 12 is an end elevation of the motorized roller of FIG. 11;

FIG. 13 is a perspective view of another belted conveyor section having a motorized or self-driven roller or pulley in accordance with the present invention; and

FIG. 14 is a perspective view of a roller conveyor section having a motorized or self-driven roller in accordance with the present invention.

### DESCRIPTION OF THE PREFERRED EMBODIMENTS

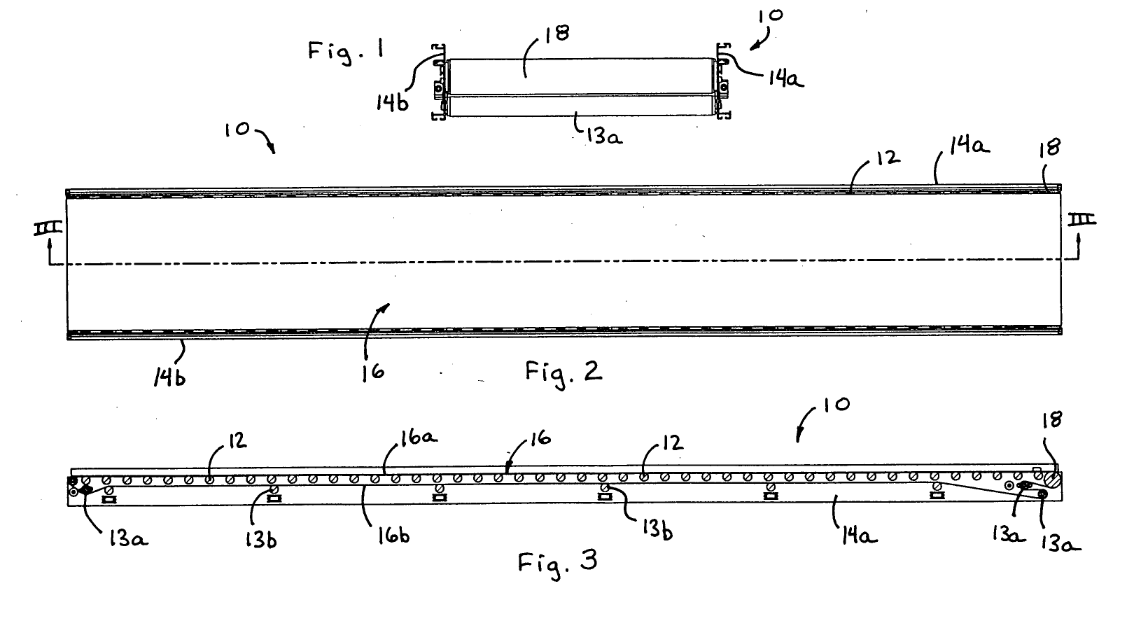

Referring now to the drawings and the illustrative embodiments depicted therein, a belted conveyor or belted conveyor section 10 includes at least one idler pulley or roller 12 and a motorized pulley or roller 18 mounted to and extending between a pair of opposite sidewalls 14a, 14b (FIGS. 1-3). Motorized roller or pulley 18 is operable to drive a continuous belt 16 that is routed or reeved around motorized roller 18 and the idler rollers 12 of conveyor 10. Motorized pulley 18 may be generally flush mounted at and between sidewalls 14a, 14b of belt conveyor 10, such that a portion of the motorized roller or pulley does not extend through the sidewalls and outwardly from the sidewalls, as discussed below.

As shown in FIGS. 1-3, belt conveyor 10 may comprise an elongated conveyor or conveyor section having a plurality of idler rollers 12 spaced therealong for supporting an upper run or conveying surface 16a of conveyor belt 16. Belt conveyor 10 may also include a plurality of reversing and tensioning rollers 13a at one or both ends for reversing the belt and for adjusting the tension in belt 16 via adjustment of one or more of the rollers 13a at the sidewalls. One or more lower support rollers 13b may be provided along the conveyor for supporting a lower run 16b of conveyor belt 16 along the conveyor or conveyor section 10. The idler rollers 12 and tensioning and/or reversing rollers 13a, 13b may be any type of rollers, such as conventional, freely rotating rollers, such as the types commercially available from various sources. Optionally, the belted conveyor may include one or more support plates or slider beds between the motorized roller and an opposite end roller to support the belt between the ends of the conveyor or conveyor section, without affecting the scope of the present invention. Optionally, and as shown in FIG. 13 and discussed below, a belt conveyor 10′ may comprise a zoned conveyor arranged in two or more tandem zones 11a, 11b, 11c, with each zone having a respective motorized roller or pulley 18″ that is operable to drive the continuous belt 16′ of the respective zone.

Belt conveyor 10, 10′ may comprise a generally straight conveyor section, such as shown in FIGS. 1-3 and 13 or such as the type disclosed in U.S. patent application, Ser. No. 10/358,690, filed Feb. 5, 2003 by Cotter et al. for BELT CONVEYOR (Attorney Docket SIE04 P-100A), which is hereby incorporated herein by reference, or may comprise a curved belt conveyor section, such as a known type of curved belt conveyor or such as the type disclosed in U.S. patent application, Ser. No. 10/411,757, filed Apr. 11, 2003 by Cotter et al. for CURVED BELT CONVEYOR (Attorney Docket SIE04 P-102C), which is hereby incorporated herein by reference, without affecting the scope of the present invention. The continuous belt or belts of the conveyor may comprise a known or conventional conveyor belt, or may optionally comprise a belt having an enhanced stretch capability or characteristic, such as a belt of the type disclosed in U.S. patent application, Ser. No. 10/358,690, filed Feb. 5, 2003 by Cotter et al. for BELT CONVEYOR (Attorney Docket SIE04 P-100A), which is hereby incorporated herein by reference, without affecting the scope of the present invention.

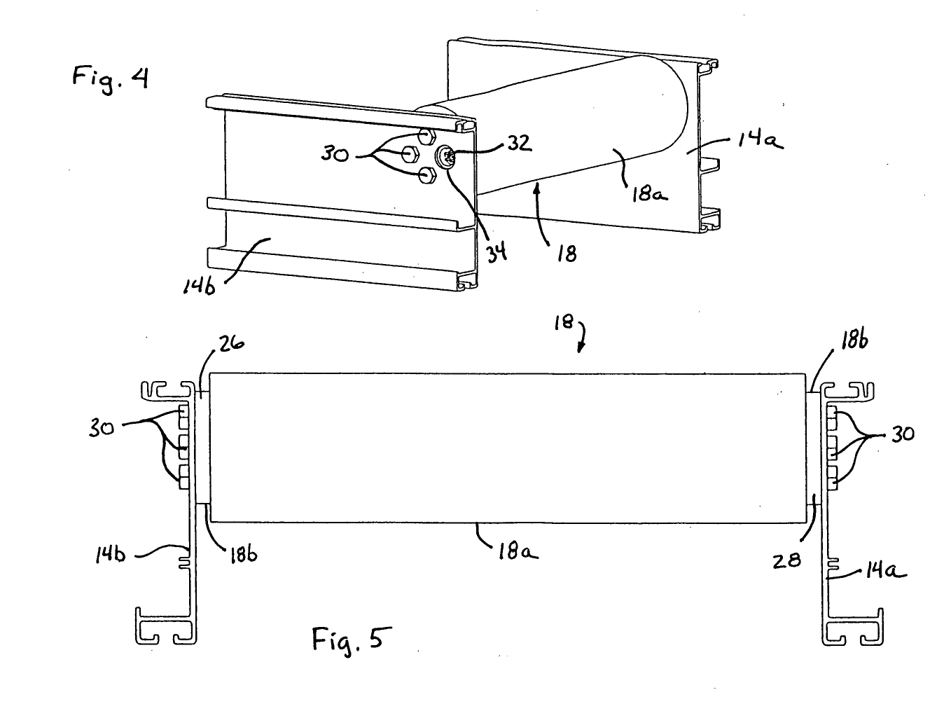

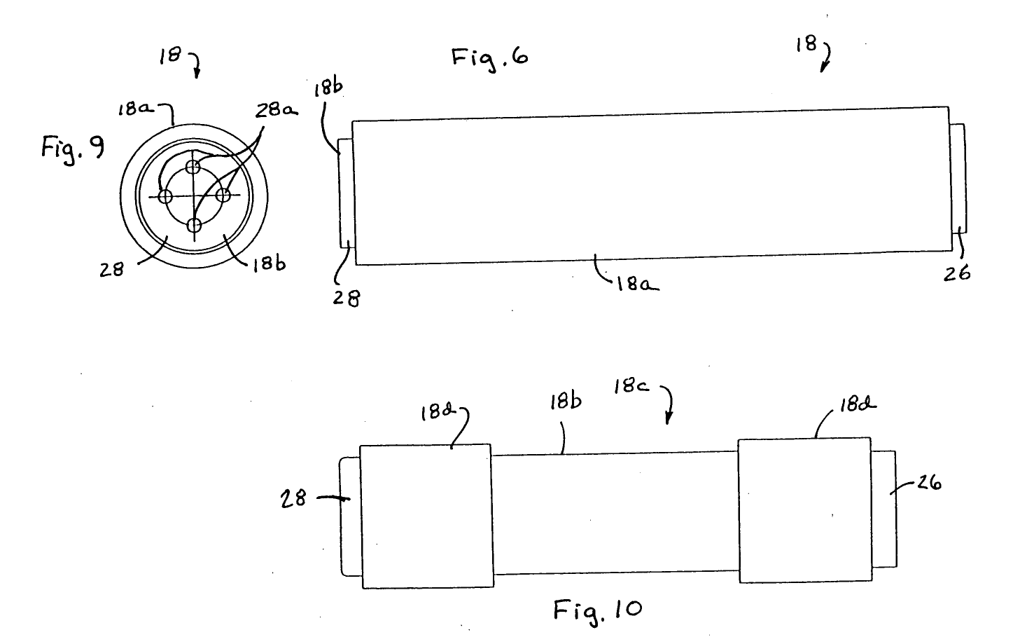

Motorized or powered or self-driven roller or pulley 18 may comprise a motorized or self-driven roller with an internal motor that is operable to rotate a roller portion 18a of the roller relative to a shaft portion or axle portion or non-rotatable portion 18b of the motorized roller 18 (FIGS. 5-9). The non-rotatable portion 18b of motorized roller 18 is attachable to and between the mounting portions or sidewalls 14a, 14b of the conveyor and may include a mounting member or hub 26, 28 at each end of the roller. The mounting hubs 26, 28 may extend from the ends of the roller portion and may mount to the sidewalls 14a, 14b, respectively, of conveyor 10, such that motorized roller 18 is positioned between sidewalls 14a, 14b of the belted conveyor. As can be seen with reference to FIGS. 7-9, mounting hub 26 (FIGS. 7 and 8) includes a plurality of openings 26a (such as the three threaded openings 26a in the illustrated embodiment), while mounting hub 28 (FIG. 9) includes a plurality of openings 28a (such as the four threaded openings 28a in the illustrated embodiment) for receiving fasteners 30 (FIGS. 4 and 5) therein to secure the mounting hubs 26, 28 of motorized roller 18 to the respective sidewalls 14a, 14b, as discussed below.

At least one of the mounting hubs 26, 28 may be a longitudinally movable or adjustable hub or a floating hub that is movable relative to the roller portion, so that at least one end or hub may be withdrawn or retracted during installation of roller 18 to provide clearance to insert roller 18 between the sidewalls 14a, 14b of conveyor 10. The roller 18 thus may be compressed or retracted and lowered or dropped generally vertically downward (or raised generally vertically upward) between the sidewalls and into general alignment with the appropriate mounting holes on the sidewalls for receiving fasteners 30 therethrough to mount or secure the roller to the sidewalls. The floating hub or hubs 26, 28 may thus adjust the width of the roller and may accommodate for manufacturing variances in the motorized roller and conveyor sidewalls or mounting portions. Because the mounting hub or hubs 26, 28 may be retracted or compressed during installation (and may remain at least temporarily in their retracted position), the motorized roller 18 may be lowered or raised while in a generally horizontal orientation until the roller is positioned between the sidewalls and the openings 26a, 28a are generally aligned with the mounting holes in the sidewalls 14a, 14b. As the fasteners 30 are driven into place and tightened to affix or secure the roller to the sidewalls, the floating hub or hubs 26, 28 may be moved or pulled outwardly by the fasteners to close any gap between the hubs and the sidewalls.

Sidewalls 14a, 14b have a plurality of holes or openings for receiving the fasteners 30 therethrough for securing roller 18 to the sidewalls. Mounting hub 26 may include an electrical connector 32 for connecting to an electrical lead or wire or connector (not shown) at the sidewall 14a to provide power and/or control to the motorized roller 18. Connector 32 may be generally aligned with an opening 34 in sidewall 14a to facilitate electrical connection to connector 32. In the illustrated embodiment, connector 32 comprises a multi-pin connector having multiple pins or connecting elements protruding therefrom for insertion into or engagement with a correspondingly formed connector at the side channel of sidewall 14a. The electrical connector 32 is recessed within the outer face or end of the hub 26 so that the electrical connector does not protrude from the hub and interfere with the sidewall or mounting portions of the conveyor during installation of the motorized roller. Accordingly, after roller 18 has been moved or lowered or raised into place and secured to the sidewalls 14a, 14b via fasteners 30, the electrical connector at the sidewall of the conveyor may be readily plugged into or connected to connector 32 of motorized roller 18 to complete the installation of the roller to the conveyor. When the motorized roller is mounted to the sidewalls, the electrical connector and connecting elements of the motorized roller thus may be positioned substantially or entirely between the sidewalls of the conveyor. The electrical connection may be a plug and socket type connection or other multi-pin type connection or the like, without affecting the scope of the present invention.

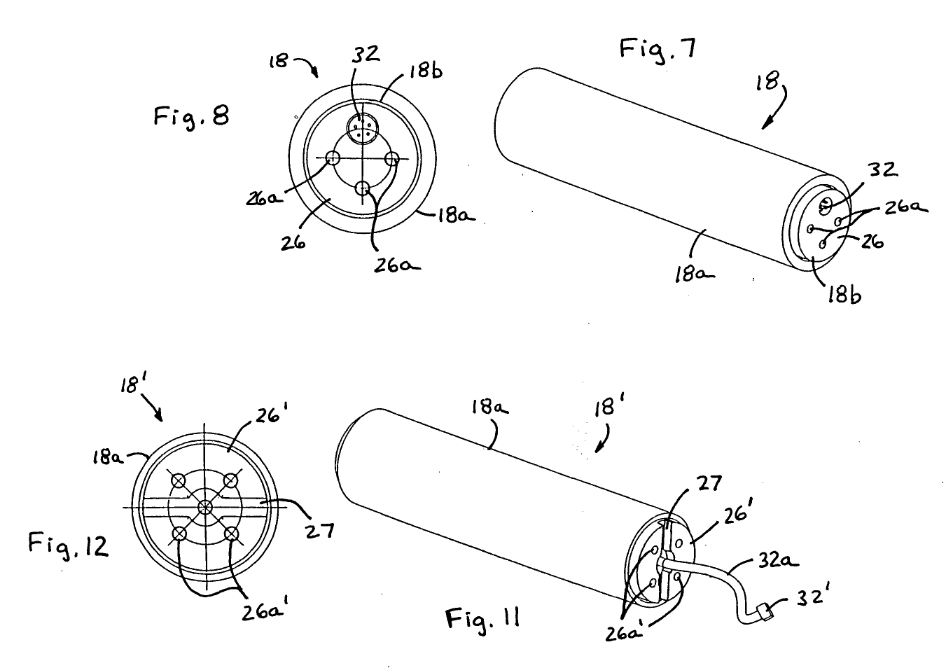

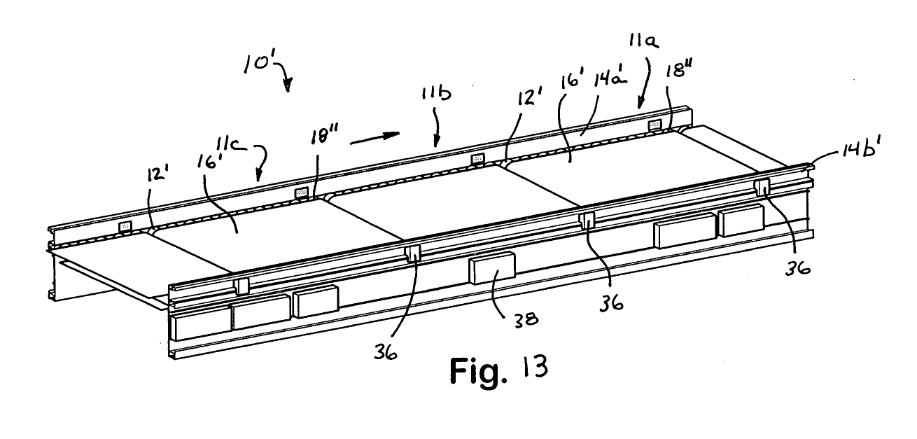

Optionally, and with reference to FIGS. 11 and 12, a mounting hub 26′ of a motorized pulley or roller 18′ may include an electrical connector 32′ that comprises a lead or wire 32a, such that the connector 32′ may extend from the roller 18′ for connection to a corresponding lead or wire or connector at the sidewall or mounting portion of the conveyor. Lead or wire 32a may extend from a generally central region of mounting hub 26′, and mounting hub 26′ may include a channel or groove 27 at least partially across, such as generally diametrically along, the face of the mounting hub. The groove 27 may allow the wire 32a to be positioned within the groove 27 and between the mounting hub 26′ and the sidewall of the conveyor, while allowing the mounting hub to engage the sidewall and generally flush mount the roller to the sidewalls. Such an arrangement may be desired in applications where the wire 32a and connector 32′ may connect to an electrical connector at the inner side of the sidewall, or where it may not be desired or feasible for the wire 32a and connector 32′ to extend through the sidewall to the side channel area. The electrical connection between the connector 32′ and the conveyor connector may be made before the motorized roller is vertically moved or raised or lowered into place between the sidewalls or mounting portions of the conveyor. When the motorized roller is mounted to the sidewalls, the electrical connector of the motorized roller thus may be positioned substantially or entirely between the sidewalls of the conveyor. Mounting hub 26′ may include four threaded openings 26a′ at its outer face for receiving the fasteners at the sidewall to mount or affix the mounting hub 26′ and motorized roller 18′ to the sidewall, such as in a similar manner as described above.

Optionally, and as shown in FIG. 10, the motorized roller 18 may include an inner power pack portion or cartridge 18c that houses the internal motor and that includes the non-rotatable portion 18b and a pair of raised portions 18d circumferentially around the non-rotatable portion 18b for engaging and supporting the roller portion or shell 18a therearound. The roller portion 18a may comprise a generally cylindrical sleeve that may slide over the raised portions 18d and engage the raised portions 18d to secure the roller portion 18a to the power pack or cartridge 18c. The internal motor may be operable to rotatably drive the raised portions 18d relative to the non-rotatable portion 18b and hubs 26, 28 to rotate the roller portion 18a relative to the non-rotatable portion 18b and hubs 26, 28.

Motorized roller 18 may comprise any type of internal motor or power source for rotatably driving the roller portion of the roller relative to the non-rotatable portion of the roller. For example, motorized roller 18 may be of the type commercially available from various sources, such as a 12-volt DC or 24-volt DC motorized roller or the like. For example, the motorized roller may include aspects and components of commercially available motorized rollers or pulleys, such as the motorized roller commercially available from Siemens Logistics and Assembly Systems Inc., and as implemented in the C-L100 Conveyor System. Optionally, the motorized roller may comprise a DC motorized roller, such as a 12-volt DC motorized roller or the like, such as a roller of the type disclosed in U.S. Pat. No. 6,244,427, the disclosure of which is hereby incorporated herein by reference. Optionally, the motorized roller may comprise a 24-volt DC motorized roller or a 42-volt DC motorized roller or a 48-volt DC motorized roller or the like. For example, the motorized roller may comprise a 48-volt DC motorized roller having a diameter of approximately 100 mm (as shown in FIGS. 1-12), or any other desired or appropriate diameter (such as a roller having a diameter of approximately 50 mm, such as shown in FIG. 13), and an overall width of between 450 mm and 900 mm, or any other desired width to span the gap between the sidewalls. The 48-volt DC motorized roller may comprise a DC brushless motor and may be operable, for example, at speeds between approximately 130 rpm and 1,150 rpm, and may provide an output of approximately 3 to 40 Nm of torque at approximately 400 rpm and approximately 1.5 Nm of torque at approximately 1,150 rpm. It is further envisioned that the motorized roller may comprise other DC powered motorized rollers, or may comprise an AC powered motorized roller, such as described in U.S. Pat. No. 5,442,248, the disclosure of which is hereby incorporated herein by reference, without affecting the scope of the present invention. The motor of the motorized roller may drive the roller portion directly, such as disclosed in U.S. Pat. No. 6,244,427, or may drive the roller via a gear train or the like, such as disclosed in U.S. Pat. No. 5,442,248, the disclosures of which are hereby incorporated herein by reference. The motorized roller 18 thus is operable to drive the continuous conveyor belt 16 which moves along the idler rollers or pulleys 12, which freely rotate about their shaft portions to guide and support the belt 16 along the conveyor 10 (or to drive respective belts 16′ around the rollers 12′ of the respective zones or segments 11a, 11b, 11c of conveyor 10′). The idler rollers may comprise any type of conventional idler rollers, such as the types commercially available from various sources. Optionally, it is envisioned that the idler rollers may have hubs or mounting ends similar to those of motorized roller 18, such that the idler rollers are also generally flush-mounted within and between the sidewalls of the conveyor in a similar manner as described above with respect to the motorized roller or pulley.

Referring now to FIG. 13, a belt conveyor 10′ may have a plurality of zones 11a, 11b, 11c, each of which is driven by a respective motorized roller 18″. Motorized roller 18″ is substantially similar to motorized roller or pulley 18, 18′ discussed above, such that a detailed description of the motorized roller will not be repeated herein. In such an embodiment or application, the motorized roller may have a diameter of approximately 50 mm. Although shown as having multiple idler rollers 12′ between the sidewalls 14a′, 14b′ and along each of the zones 11a, 11b, 11c, one or more zones of the segmented belt conveyor of the present invention may include a support plate or slider bed between the motorized roller 18″ and an opposite end idler roller 12′ to support the belt 16′ between the ends of the zone 11a, 11b, 11c, without affecting the scope of the present invention.

Belted conveyor 10′ may also include one or more article or product sensors 36 (such as shown in FIG. 1), such as photo sensors or photo eyes or the like, positioned along the conveyor, such as at or near a downstream end of each zone 11a, 11b, 11c, and operable to detect articles being conveyed along the zone or conveyor. A control 38 may be included to control and activate and deactivate the internal motors of the motorized or driven rollers 18″ of each zone 11a, 11b, 11c in response to the product sensors 36, as discussed below. Products sensors 36 may be any type of sensor, such as a sensor of the types disclosed in U.S. Pat. Nos. 5,582,286 and 6,253,909, and/or U.S. patent application, Ser. No. 10/605,277, filed Sep. 19, 2003 by Haan et al., for ACCUMULATING CONVEYOR SYSTEM (Attorney Docket SIE04 P-109A), which are hereby incorporated herein by reference. In the illustrated embodiment of FIG. 13, belt conveyor 10′ comprises three zones 11a, 11b, 11c, with each zone having a motorized roller, and having a product sensor 36 positioned at or toward the end of each zone or elsewhere along the zone. However, the number of zones along a conveyor section is a function of the particular application and may vary without affecting the scope of the present invention.

In the illustrated embodiment, each product sensor 36 comprises a photo sensor positioned at the downstream end of a respective zone and operable to detect products or articles as they move from the downstream end of one zone to an upstream end of the adjacent zone. The motorized or self-driven roller 18″ of each zone may be selectively activated or deactivated by control 38 in response to a corresponding product sensor 36, or in response to more than one of the products sensors positioned along the belt conveyor, to move or stop an article or articles that is/are present on the belt of the respective zone. The motorized roller thus may be directly driven and operable to selectively and independently convey or accumulate one more articles on the associated conveyor zones in response to one or more of the product sensors.

Optionally, the motorized or self-driven rollers and associated zones may be operable in a “sleep mode”, such as described in U.S. Pat. Nos. 5,582,268 and 6,253,909, the disclosures of which are hereby incorporated herein by reference. In such a mode of operation, the control may activate the self-driven or motorized roller of a particular zone in response to an article being detected at the beginning of the zone (or at the end of the immediate upstream zone), and may deactivate the motorized roller after the article has moved to the next or downstream zone, such that the motorized roller of a particular zone is only activated when an article is present at the zone and when the article is to be conveyed along the zones of the conveyor. If the downstream zones are not activated, then the motorized roller of the particular zone may be deactivated or stopped to accumulate the detected article or articles on that particular zone of the conveyor. Such a sleep mode operation thus only activates the motorized roller of a zone when an article to be conveyed is present at the particular zone, and thus reduces operation of the motorized rollers to increase the life cycle of the rollers.

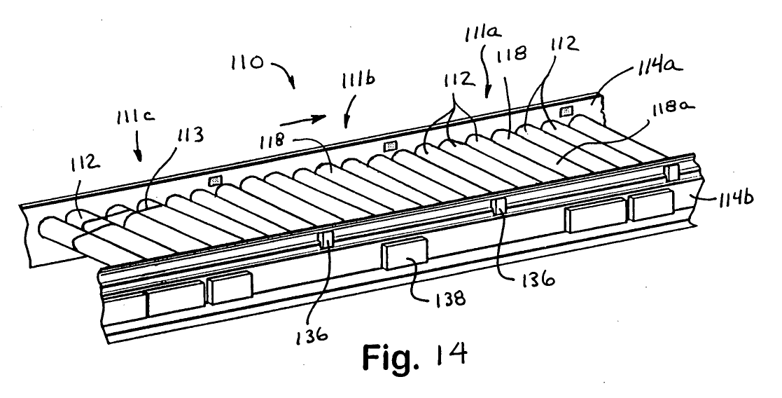

Although shown and described as a motorized roller for a belt conveyor or belt conveyor section or zoned or segmented belt conveyor, the motorized roller of the present invention may be equally suitable for use in other motorized roller applications, without affecting the scope of the present invention. For example, the motorized roller may be implemented with a roller conveyor and may be operable to rotatably drive a plurality of idler rollers via various drive means. Referring now to FIG. 14, a motorized roller 118 is positioned between opposite mounting portions or sidewalls 114a, 114b of a roller conveyor 110 in a similar manner as described above with respect to belt conveyor 10, and is operable to rotatably drive a plurality of idler rollers 112 of the roller conveyor. In such an embodiment or application, the motorized roller may have a diameter of approximately 50 mm. The roller conveyor 110 may comprise multiple zones 111a, 111b, 111c, with each zone comprising a motorized roller 118 and a respective set of idler rollers 112. The idler rollers 112 comprise a plurality of idler or freely rotating or slave rollers and may define a conveying surface of roller conveyor 110.

The motorized roller 118 may be substantially the same as motorized roller 18, 18′, 18″ discussed above, such that a detailed description of the motorized roller will not be repeated herein. Suffice it to say that the motorized roller may have a roller portion 118a that is rotatably driven about a non-rotatable portion by an internal motor. The roller portion 118a may cooperate with the idler rollers to define the conveying surface of the roller conveyor. The non-rotatable portion may be generally flush mounted to the opposed inner surfaces of the sidewalls of the roller conveyor and may include one or more floating or adjustable hubs to facilitate mounting the motorized roller at and between the sidewalls in a similar manner as described above. Each motorized roller 118 of the zones may drive the idler rollers of a respective zone via a plurality of O-rings or drive members or bands 113 connected between the motorized roller 118 and adjacent idler rollers 112 and between adjacent pairs of idler rollers 112, as is known in the art of roller conveyors.

Idler rollers 112 of roller conveyor 110 may be conventional, freely rotating rollers, such as the types commercially available from various sources. The shafts of the idler rollers may be mounted within holes or apertures in the sidewalls 114a, 114b to limit or substantially preclude rotation of the shafts when the roller portions of the idler rollers are rotated due to the driving of the drive members 113 via activation of motorized roller 118. Optionally, the idler rollers may have hubs or mounting portions similar to motorized roller 18, 18′, 18″, 118, such that the idler rollers are generally flush mounted and thus do not extend through the sidewalls of the roller conveyor.

Optionally, roller portion 118a of motorized roller 118 may include grooves or indentations circumferentially therearound for receiving or partially receiving drive members 113, in order to limit or substantially preclude longitudinal movement of the drive members along motorized roller 118 during operation of roller conveyor 110. The idler rollers 112 may likewise include grooves or circumferential indentations therearound for receiving the O-rings 113, such as is known in the art of roller conveyors.

Accordingly, when motorized or self-driven roller 118 is activated, the roller portion of the self-driven roller is directly rotated or driven relative to its non-rotatable portion. Rotation of the roller portion of driven roller 118 drives the drive members 113 positioned around the driven roller 118 to rotatably drive the idler rollers 112 positioned adjacent to the motorized roller 118. The other idler rollers 112 of each zone may be rotatably driven by other O-rings or drive members around adjacent pairs of idler rollers. The motorized roller 118 may be selectively activated to rotate the roller portion in either direction or to stop rotation of the roller portion, in order to convey articles in either direction along the zone of the conveyor and/or to accumulate articles on the particular zone of the roller conveyor, and may be selectively activated in response to an article sensor or sensors 136 and a control 138 in a similar manner as discussed above with respect to belt conveyor 10. The motorized roller may be operable to rotatably drive idler rollers that are positioned or oriented generally normal or transverse to the sidewalls of the conveyor (as shown in FIG. 14) or may rotatably drive skewed idler rollers or the like or may rotatably drive tapered idler rollers around a curved roller conveyor section or the like, without affecting the scope of the present invention.

Although shown in FIG. 14 as being mounted between the sidewalls and adjacent to the idler rollers of the roller conveyor, it is envisioned that the motorized roller of the present invention may be positioned elsewhere at the conveyor and may be operable to rotatably drive the roller conveyors via other drive means, without affecting the scope of the present invention. For example, the motorized roller may be implemented with a tape drive conveyor system (such as the type disclosed in U.S. patent application, Ser. No. 10/411,924, filed Apr. 11, 2003 by Cotter et al. for TAPE DRIVE CONVEYOR (Attorney Docket SIE04 P-101C), which is hereby incorporated herein by reference), and may be generally flush mounted to and between the mounting portions of the tape drive system and generally below the idler rollers, such as to and between the sidewalls of the conveyor, or to and between the ends of a mounting bracket positioned generally below the idler rollers of the conveyor. Optionally, the motorized roller may be implemented with a transverse drive system (such as the type disclosed in U.S. patent application, Ser. No. 10/710,809, filed Aug. 4, 2004 by Tasma et al. for MOTORIZED ROLLER TRANSVERSE DRIVE (Attorney Docket SIE04 P-112A), which is hereby incorporated herein by reference), and may be generally flush mounted to and between the ends of the mounting portions of the transverse drive system, such as to and between the mounting portions of a mounting bracket or brackets, positioned generally along one of the sidewalls of the conveyor and generally below the idler rollers of the conveyor. Optionally, the motorized roller may be implemented with a diverter system (such as the type disclosed in U.S. patent application, Ser. No. 10/710,824, filed Aug. 5, 2004 by Ehlert for STEERABLE DIVERTER SYSTEM (Attorney Docket SIE04 P-113A), which is hereby incorporated herein by reference), and may be generally flush mounted to and between the mounting portions of the diverter system, such as to and between the ends of a mounting bracket or brackets positioned generally below one of the rows of diverter wheels of the diverter system. It is envisioned that a motorized roller having aspects of the motorized roller of the present invention may be implemented in any such applications, or in other applications where a motorized roller or directly driven roller of self driven roller may be desired or appropriate, without affecting the scope of the present invention.

Therefore, the flush mounted motorized roller of the present invention may be secured to and between opposite sidewalls or mounting portions of a conveyor section or system with minimal interference with the area along the side channels of the sidewalls or the area outward of the mounting portions. The motorized roller may be readily mounted to and between the opposite sidewalls or mounting portions by moving or lowering or raising the motorized roller into position between the sidewalls or mounting portions and tightening or securing fasteners through the sidewalls or mounting portions and into the ends or hubs of the roller. The electrical connection to the motorized roller may be made by a plug and socket type connection between a conveyor connector and a connector at an end or hub of the motorized roller that is accessible through an opening or aperture in the sidewall or mounting portion of the conveyor. The motorized roller thus may be readily installed and connected at the sidewalls or mounting portions of the conveyor, and the motorized roller and electrical connector of the motorized roller may be substantially or entirely contained between the sidewalls of the conveyor when the motorized roller is mounted to the sidewalls of the conveyor.

Changes and modifications in the specifically described embodiments may be carried out without departing from the principles of the present invention, which is intended to be limited only by the scope of the appended claims as interpreted according to the principles of patent law.

1. A conveyor for conveying articles along a conveying surface, said conveyor comprising:
a pair of opposite sidewalls;
a motorized roller mounted to said sidewalls, said motorized roller comprising a non-rotatable portion mounted to and between said sidewalls, a rotatable roller portion and an internal motor operable to rotate said roller portion relative to said non-rotatable portion, said non-rotatable portion being positionable entirely between said sidewalls, said non-rotatable portion being mounted to said sidewalls via at least one fastener extending through a respective sidewall and at least partially through a respective end of said non-rotatable portion, said motorized roller including an electrical connector for connecting said internal motor to a control of said conveyor, said electrical connector being positioned entirely between said sidewalls when said motorized roller is mounted to said sidewalls;
at least one other roller mounted to said sidewalls; and
at least one drive member reeved around said motorized roller and at least one other roller, wherein actuation of said motor of said motorized roller drives said at least one drive member and said at least one other roller.

2. The conveyor of claim 1, wherein said conveyor comprises a belt conveyor, said at least one drive member comprising a continuous belt reeved around said motorized roller and said at least one other roller and defining a conveying surface of said belt conveyor.

3. The conveyor of claim 1, wherein said conveyor comprises a roller conveyor, said at least one other roller comprising a plurality of idler rollers defining a conveying surface of said roller conveyor.

4. The conveyor of claim 1, wherein at least one end of said non-rotatable portion is adjustable to adjust a length of said non-rotatable portion to adapt said non-rotatable portion to fit between said sidewalls.

5. The conveyor of claim 4, wherein said at least one end of said non-rotatable portion is retractable to a retracted position such that said non-rotatable portion fits between said sidewalls, said at least one end being extendable to an extended position via tightening of said at least one fastener.

6. The conveyor of claim 1, wherein said non-rotatable portion is secured to said sidewalls via at least two fasteners extending through a respective one of said sidewalls and at least partially through a respective one of said ends of said non-rotatable portion.

7. The conveyor of claim 1, wherein said electrical connector is at one of said ends of said motorized roller.

8. The conveyor of claim 7, wherein said electrical connector comprises connecting elements recessed within said end of said motorized roller.

9. The conveyor of claim 8, wherein a respective one of said sidewalls includes a hole positioned adjacent to said electrical connector when said motorized roller is mounted to said sidewalls, said connecting elements being connectable to a second connector of said conveyor for powering and/or controlling said motorized roller.

10. The conveyor of claim 7, wherein said electrical connector comprises an electrical wire and a connecting element at the end of said wire, said wire being positionable along a groove in said end, said connecting element being connectable to a second connector of said conveyor.

11. The conveyor of claim 1, wherein said conveyor comprises a plurality of zones, each of said zones including a respective motorized roller that is operable to drive said at least one drive member and said at least one other roller of said zone.

12. The conveyor of claim 11 including at least one article sensor operable to detect articles on said conveyor.

13. The conveyor of claim 12, wherein said motorized rollers are selectively activatable in response to said at least one article sensor to accumulate articles on said zones of said conveyor.

14. The conveyor of claim 1, wherein said motorized roller is selectively activatable to selectively drive said at least one drive member and said at least one other roller.

15. A motorized roller operable to rotatably drive at least one other roller of a conveyor via at least one drive member reeved around said motorized roller and the at least one other roller, the at least one other roller being mounted to opposite sidewalls of the conveyor, said motorized roller comprising:
a non-rotatable portion, said non-rotatable portion having opposite ends, at least one of said ends being retractable to a retracted position, said non-rotatable portion being adapted to fit between opposite mounting portions of the conveyor when said at least one of said ends is in said retracted position, said non-rotatable portion being securable to the opposite mounting portions and entirely between the opposite mounting portions, said non-rotatable portion being mounted to the opposite mounting portions via at least one fastener extending through a respective mounting portion and at least partially through a respective one of said ends of said non-rotatable portion;
a rotatable roller portion rotatable about said non-rotatable portion;
an internal motor positioned within said motorized roller and operable to rotatably drive said roller portion relative to said non-rotatable portion; and
an electrical connector for electrically connecting said internal motor to a control of a conveyor, said electrical connector being positioned entirely within the opposite mounting portions of the conveyor when said motorized roller is mounted to mounting portions of the conveyor.

16. The motorized roller of claim 15, wherein said motorized roller is operable to rotatably drive a continuous belt or drive member reeved around said motorized roller and said at least one other roller and defining a conveying surface of said conveyor.

17. The motorized roller of claim 15, wherein said motorized roller is operable to rotatably drive a plurality of idler rollers via the at least one drive member.

18. The motorized roller of claim 15, wherein said at least one of said ends of said non-rotatable portion is retractable to said retracted position and is extendable to an extended position via tightening of said at least one fastener.

19. The motorized roller of claim 15, wherein said non-rotatable portion is securable to the opposite mounting portions via at least two fasteners extending through a respective one of the mounting portions and at least partially through a respective one of said ends of said non-rotatable portion.

20. The motorized roller of claim 15, wherein said electrical connector includes connecting elements recessed within an end of said motorized roller, said recessed connecting elements being configured to connect to a conveyor connector extending through a hole in a respective one of the mounting portions.

21. The motorized roller of claim 15, wherein said electrical connector includes a wire and a connecting element at an end of said wire, said wire being positionable along a groove in said end so that said ends and said wire are positioned entirely between the mounting portions when said motorized roller is mounted to the mounting portions.

22. A method of installing a motorized roller to a conveyor comprising:
providing a motorized roller having a non-rotatable portion having opposite ends, a rotatable roller portion rotatable about said non-rotatable portion, and an internal motor operable to rotatably drive said roller portion relative to said non-rotatable portion, said motorized roller including an electrical connector contained entirely between said opposite ends of said roller;
retracting at least one of said ends of said non-rotatable portion to a retracted orientation;
generally vertically moving said motorized roller between opposite mounting portions of the conveyor, said motorized roller being vertically movable to a level where said motorized roller is positioned entirely between the opposite mounting portions;
securing said ends of said non-rotatable portion to the respective mounting portions via at least one fastener extending through the mounting portion and at least partially into the respective end of said non-rotatable portion;
tightening said at least one fastener to secure said motorized roller to said mounting portions, said motorized roller and said electrical connector being entirely positioned between the mounting portions when said motorized roller is secured to said mounting portions; and
electrically connecting said electrical connector to an electrical control of the conveyor.

23. The method of claim 22, wherein said electrical connector comprises connecting elements recessed within one of said ends of said motorized roller.

24. The method of claim 23, wherein electrically connecting said motorized roller comprises inserting a conveyor connector through an opening in one of said mounting portions and connecting said conveyor connector to said recessed connecting elements.

25. The method of claim 22, wherein electrically connecting said motorized roller comprises connecting a wire lead of said motorized roller to a conveyor connector, said wire lead being positionable along a groove at one of said ends of said non-rotatable portion of said motorized roller and between said one of said ends and the respective mounting portion.

26. The method of claim 25, wherein connecting said wire lead to a conveyor connector is performed before the step of generally vertically moving said motorized roller between opposite mounting portions.

27. The method of claim 22 including extending said at least one of said ends of said non-rotatable portion to an extended position via tightening said at least one fastener.

28. The method of claim 22, wherein generally vertically moving said motorized roller comprises generally vertically moving said motorized roller between opposite mounting portions while said motorized roller is in a generally horizontal orientation.

29. The method of claim 22, wherein said at least one fastener comprises at least two fasteners.
